(19) United States
(12) Patent Application Publication
(10) Pub. No.: US 2026/0160950 A1
(43) Pub. Date: Jun. 11, 2026

(54) PHOTONIC STRUCTURES INCLUDING RING RESONATORS

(71) Applicant: GlobalFoundries U.S. Inc., Malta, NY (US)

(72) Inventors: Aneesh Dash, Bangalore (IN); Abdelsalam Aboketaf, Essex Junction, VT (US)

(21) Appl. No.: 18/976,626

(22) Filed: Dec. 11, 2024

(51) Int. Cl. G02B 6/293

(52) U.S. Cl. CPC G02B 6/29343

(57) ABSTRACT

Photonic structures including ring resonators and methods of forming such structures. The photonic structure comprises first, second, and third waveguide cores, and a first ring resonator arranged between a first portion of the first waveguide core and a portion of the second waveguide core. The photonic structure further comprises a second ring resonator arranged between a second portion of the first waveguide core and a portion of the third waveguide core.

### BACKGROUND

This disclosure relates to photonic chips and, more specifically, to photonic structures including ring resonators and methods of forming such structures.

A photonic chip includes a photonic integrated circuit comprised of photonic components, such as modulators, polarizers, and couplers, that are used to manipulate light received from a light source, such as an optical fiber or a laser. Optical networks and reconfigurable optical filters, which may include multiple optical components, are utilized in data centers for optical communication, high-performance computing, quantum computing, and artificial intelligence applications. Uniform, symmetric, and reconfigurable coupling is challenging to achieve using conventional hierarchical photonic networks.

Improved photonic structures including ring resonators and methods of forming such structures are needed.

### SUMMARY

In an embodiment of the invention, a photonic structure comprises a first waveguide core, a second waveguide core, and a third waveguide core. The photonic structure further comprises a first ring resonator arranged between a first portion of the first waveguide core and a portion of the second waveguide core. The photonic structure further comprises a second ring resonator arranged between a second portion of the first waveguide core and a portion of the third waveguide core.

In an embodiment of the invention, a method of forming a photonic structure is provided. The method comprises forming a first waveguide core, a second waveguide core, and a third waveguide core, forming a first ring resonator arranged between a first portion of the first waveguide core and a portion of the second waveguide core, and forming a second ring resonator arranged between a second portion of the first waveguide core and a portion of the third waveguide core.

### BRIEF DESCRIPTION OF THE DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention. In the drawings, like reference numerals refer to like features in the various views.

FIG. 1 is a diagrammatic top view of a structure in accordance with embodiments of the invention.

FIG. 1A is an enlarged view of a portion of FIG. 1.

FIG. 2 is a diagrammatic top view of a structure in accordance with embodiments of the invention.

FIG. 2A is an enlarged view of a portion of FIG. 2.

FIG. 3 is a diagrammatic top view of a structure in accordance with embodiments of the invention.

FIG. 3A is an enlarged view of a portion of FIG. 3.

FIG. 4 is a diagrammatic top view of a structure in accordance with embodiments of the invention.

FIG. 5 is a diagrammatic top view of a structure in accordance with embodiments of the invention.

### DETAILED DESCRIPTION

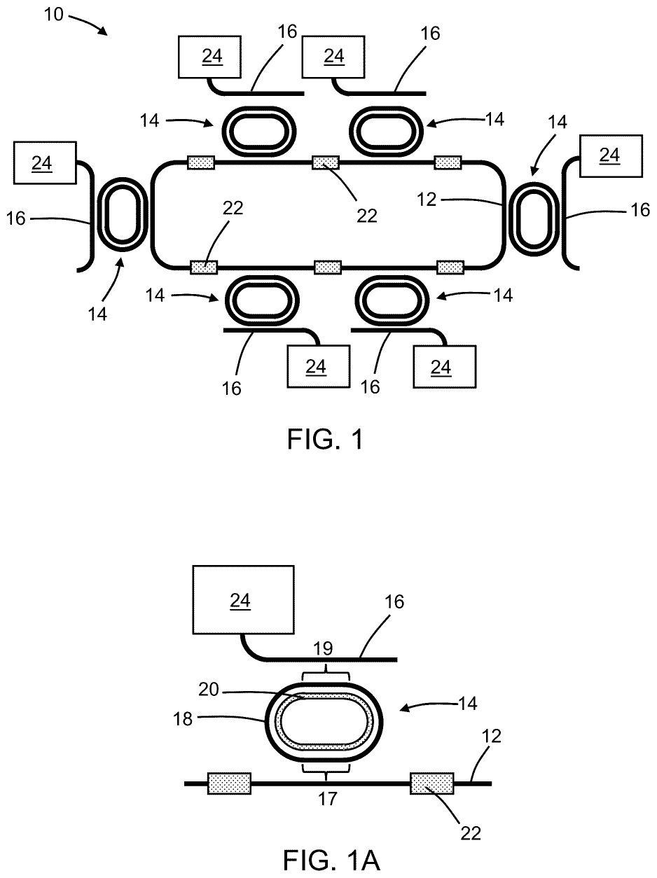

With reference to FIGS. 1, 1A and in accordance with embodiments of the invention, a photonic structure 10 for deployment on a photonic chip includes a waveguide core 12, ring resonators 14 that are arranged about the periphery of the waveguide core 12, and waveguide cores 16 that are optically coupled by the ring resonators 14 to the waveguide core 12. The waveguide core 12, the ring resonators 14, and the waveguide cores 16 may be positioned on, and above, an insulator layer of a silicon-on-insulator substrate. In an embodiment, the waveguide core 12 may have a closed shape that includes line segments and curves that are connected and meet. In an embodiment, the waveguide core 12 may have a closed shape that is oblong with line segments connected by curved corners.

Each ring resonator 14 is arranged between a portion of the waveguide core 12 and a portion of the waveguide core 16. Each of the ring resonators 14 may include a waveguide core 18 having a closed shape and a phase shifter 20. In an embodiment, each ring resonator 14 includes a portion in the form of a side section 17 adjacent to a portion of the waveguide core 12 over a coupling length, a portion in the form of another side section 19 adjacent to a portion of one of the waveguide cores 16 over a coupling length, and curved ends that connect the side sections 17, 19 to provide a closed oblong or racetrack shape. In an embodiment, the side sections 17, 19 may be linear or straight, and the curved ends may extend about an arc of 180 degrees. The side section 17 of each ring resonators 14 and the adjacent portion of the waveguide core 12 represent a directional coupler that is configured to enable light coupling and transfer across a gap therebetween. The side section 19 of each ring resonator 14 and the adjacent portion of the waveguide core 16 represent a directional coupler that is configured to enable light coupling and transfer across a gap therebetween.

Phase shifters 22 are arranged at various locations about the periphery of the waveguide core 12. In an embodiment, the phase shifters 22 may be coupled to portions of the waveguide core 12 at locations distributed about the periphery of the waveguide core 12 between the side sections 17 of the waveguide core 12 that participate in the directional couplers with the adjacent portions of the waveguide cores 16 of the ring resonators 14. The phase shifters 22 may function as tuners in the photonic structure 10 by changing a refractive index of the material of the portions of the waveguide core 12 to which they are coupled. In embodiments, the phase shifters 20 and the phase shifters 22 may be electro-optic phase shifters, thermo-optic phase shifters, nonlinear-optic phase shifters, optomechanical phase shifters, acousto-optic phase shifters, magneto-optic phase shifters, etc. In an embodiment, the phase shifter 20 of each ring resonator 14 may have a closed shape, such as a closed oblong or racetrack shape, that is positioned inside an inner perimeter of the waveguide core 18.

Each of the ring resonators 14 may be coupled by one of the waveguide cores 16 to a photonic structure 24. In an embodiment, the photonic structures 24 may be photonic integrated circuits. In an alternative embodiment, the photonic structures 24 may be optical input ports. In an alternative embodiment, the photonic structures 24 may be optical output ports. In an alternative embodiment, the photonic structures 24 may be a combination of a photonic integrated circuits, optical input ports, and/or optical output ports. The phase shifters 20 and the phase shifters 22 may be utilized to select the routing of light between the photonic structures 24 in a hub that includes the waveguide core 12 and ring resonators 14.

In an embodiment, the waveguide core 12, the waveguide core 18 of each ring resonator 14, and the waveguide cores 16 may be comprised of a material having a refractive index that is greater than the refractive index of silicon dioxide. In an embodiment, the waveguide core 12, the waveguide core 18 of each ring resonator 14, and the waveguide cores 16 may be comprised of a semiconductor material, such as single-crystal silicon, amorphous silicon, or polysilicon. In an alternative embodiment, the waveguide core 12, the waveguide core 18 of each ring resonator 14, and the waveguide cores 16 may be comprised of a dielectric material, such as silicon nitride, silicon oxynitride, or aluminum nitride. In alternative embodiments, other materials, such as a III-V compound semiconductor, lithium niobate, barium titanate, boron nitride, or diamond, may be used to form the waveguide core 12, the waveguide core 18 of each ring resonator 14, and the waveguide cores 16.

In an embodiment, the waveguide core 12, the waveguide core 18 of each ring resonator 14, and the waveguide cores 16 may be formed by patterning a layer comprised of their constituent material with lithography and etching processes. In an embodiment, an etch mask may be formed by a lithography process over the layer, and unmasked sections of the layer may be etched and removed with an etching process. In an embodiment, the waveguide core 12, the waveguide core 18 of each ring resonator 14, and the waveguide cores 16 may be formed by patterning the semiconductor material (e.g., single-crystal silicon) of the device layer of a silicon-on-insulator substrate. In an embodiment, the waveguide core 12, the waveguide core 18 of each ring resonator 14, and the waveguide cores 16 may be formed by patterning a deposited layer comprised of its constituent material (e.g., polysilicon or silicon nitride).

The waveguide core 12, the ring resonators 14, and the phase shifters 22 may act as a reconfigurable all-to-all coupling hub of a photonic network for selectively routing light between the different photonic structures 24. The ring resonators 14 are switchable and are characterized by tunable coupling, attenuation, and phase relationship for selecting a path for light in the photonic structure 10. The photonic structure 10 features reconfigurable phase tuning between individual ring resonators 14 and reconfigurable attenuation between individual ring resonators 14. The photonic structure 10 may be deployed in a wavelength selective network hub with variable amplitude and phase coupling between elements, as well as path switching options, by-pass options, and alternate path selection during faults. The phase-tuning between ring resonators 14 may be used to tune the spectral spacing between resonances, which may be useful for advanced signal filtering, signal jamming, and/or signal blocking.

In an alternative embodiment that is directed to a higher order photonic network, one or more of the ring resonators 14 may couple the photonic structure 10 with an adjacent photonic structure (not shown) that is configured with ring resonators similar to the ring resonators 14 that are peripherally arranged about the perimeter of a waveguide core similar to the waveguide core 12, waveguide cores associated with the ring resonators that are similar to the waveguide cores 16, and phase shifters similar to the phase shifters 22.

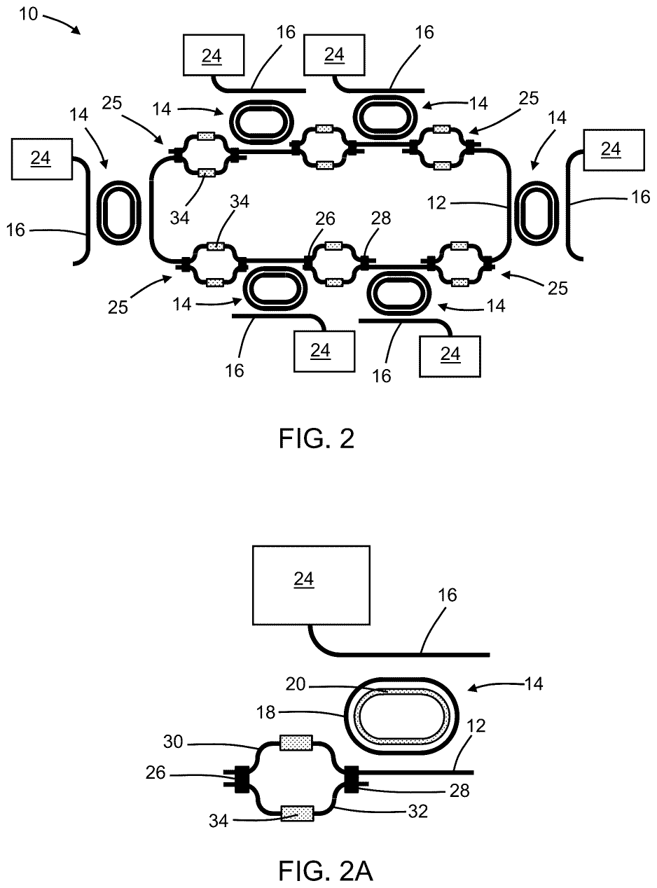

With reference to FIGS. 2, 2A and in accordance with alternative embodiments, the phase shifters 22 may be replaced in the photonic structure 10 by Mach-Zehnder interferometers 25. Each Mach-Zehnder interferometer 25 includes an optical coupler 26, an optical coupler 28, and arms 30, 32 that are separately routed from the optical coupler 26 to the optical coupler 28. The arms 30, 32 of each Mach-Zehnder interferometer 25 may be coupled by the optical couplers 26, 28 to portions of the waveguide core 12 that are arranged between the portions of the waveguide core 12 that are coupled to the ring resonators 14. The arms 30, 32 of each Mach-Zehnder interferometer 25 may integrate a phase shifter 34. The phase shifters 34 may be used to generate a phase difference between the light propagating in the different arms 30, 32 of each Mach-Zehnder interferometer 25.

In an embodiment, the optical couplers 26, 28 may be multimode interference couplers. In alternative embodiments, the optical couplers 26, 28 may be a different type of structure capable of transferring light, such as a directional coupler, a Y-junction coupler, or a trident coupler, that is configured to split or combine optical power. In embodiments, the phase shifters 34 may be electro-optic phase shifters, thermo-optic phase shifters, nonlinear-optic phase shifters, optomechanical phase shifters, acousto-optic phase shifters, magneto-optic phase shifters, etc.

The Mach-Zehnder interferometers 25 may enable a combination of tuning and switching in the photonic structure 10.

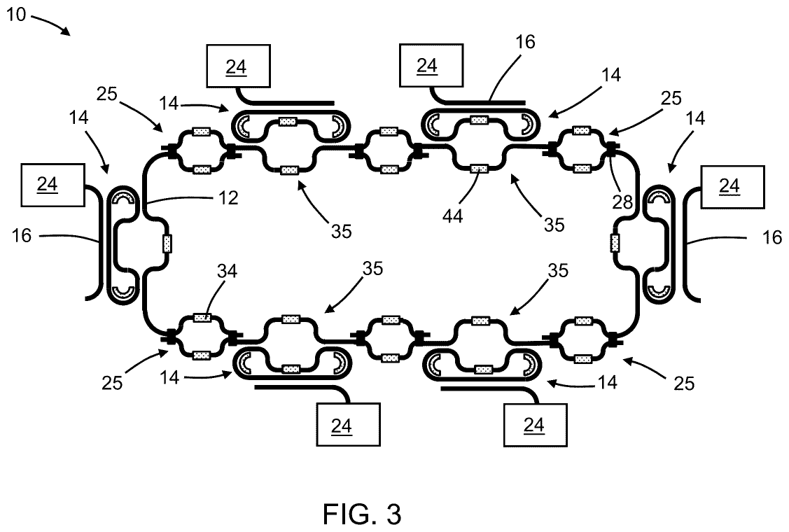

With reference to FIGS. 3, 3A and in accordance with alternative embodiments, each of the ring resonators 14 may integrate a Mach-Zehnder interferometer 35 that represents a tunable hybrid optical coupler in contrast to the directional coupler in FIGS. 2, 2A. Each Mach-Zehnder interferometer 35 includes an optical coupler 36, an optical coupler 38, and arms 40, 42 that are separately routed from the optical coupler 36 to the optical coupler 38. The arm 40 of each Mach-Zehnder interferometer 35 may include a portion of the waveguide core 18 of the ring resonator 14, and the arm 42 of each Mach-Zehnder interferometer 35 may include a portion of the waveguide core 12. The arms 40, 42 of each Mach-Zehnder interferometer 35 extend between the optical couplers 36, 38, which are directional couplers in the representative embodiment, that provide light coupling between the ring resonator 14 and portions of the waveguide core 12. In alternative embodiments, the optical couplers 36, 38 may be multimode interference couplers, Y-junction couplers, or trident couplers that are configured to split or combine optical power.

The arms 40, 42 of each Mach-Zehnder interferometer 35 may integrate a phase shifter 44. In embodiments, the phase shifters 44 may be electro-optic phase shifters, thermo-optic phase shifters, nonlinear-optic phase shifters, optomechanical phase shifters, acousto-optic phase shifters, magneto-optic phase shifters, etc. The phase shifters 44 may be used to generate a phase difference between the light propagating in the different arms 40, 42 of each Mach-Zehnder interferometer 35 such that the light coupling is tunable. The phase shifter 20 of each ring resonator 14 may be split into elements that are arranged adjacent to the opposite curved ends of the waveguide core 18.

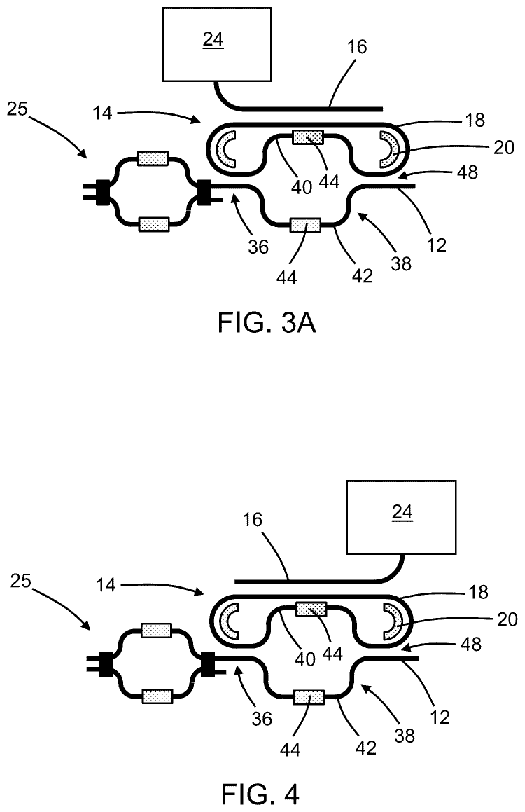

With reference to FIG. 4 and in accordance with alternative embodiments, each photonic structure 24 may be coupled to an opposite end of the waveguide core 16. The change in location for the photonic structure 24 may be employed to alter the positioning relative to the direction of propagation of light in the photonic structure 10.

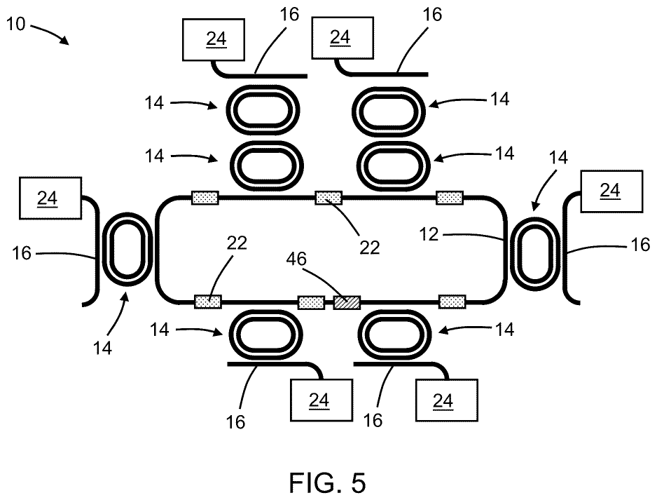

With reference to FIG. 5 and in accordance with alternative embodiments, the photonic structure 10 may include multiple ring resonators 14 that are arranged between a portion of the waveguide core 12 and a portion of one of the waveguide cores 16. The multiple ring resonators 14 may be used to transfer light between the different portions of the waveguide cores 12, 16. In an alternative embodiment, the multiple ring resonators 14 may incorporate Mach-Zehnder interferometers 35 that represent tunable hybrid optical couplers.

A variable optical attenuator 46 may be coupled to a portion of the waveguide core 12, such as a portion of the waveguide core 12 that includes one of the phase shifters 22 and that is arranged between portions of the waveguide core 12 that participate in the directional couplers with the waveguide cores 18 of the ring resonators 14. The variable optical attenuator 46 may be utilized to attenuate the optical power of light propagating through the associated portion of the waveguide core 12. In an alternative embodiment, the phase shifter 22 may be omitted such that only the variable optical attenuator 46 is coupled to a portion of the waveguide core 12.

The methods as described above are used in the fabrication of integrated circuit chips. The resulting integrated circuit chips can be distributed by the fabricator in raw wafer form (e.g., as a single wafer that has multiple unpackaged chips), as a bare die, or in a packaged form. The chip may be integrated with other chips, discrete circuit elements, and/or other signal processing devices as part of either an intermediate product or an end product. The end product can be any product that includes integrated circuit chips, such as computer products having a central processor or smartphones.

References herein to terms modified by language of approximation, such as “about”, “approximately”, and “substantially”, are not to be limited to the precise value or precise condition as specified. In embodiments, language of approximation may indicate a range of +/−10% of the stated value(s) or the stated condition(s).

References herein to terms such as “vertical”, “horizontal”, etc. are made by way of example, and not by way of limitation, to establish a frame of reference. The term “horizontal” as used herein is defined as a plane parallel to a conventional plane of a semiconductor substrate, regardless of its actual three-dimensional spatial orientation. The terms “vertical” and “normal” refer to a direction or plane in the frame of reference perpendicular to the horizontal plane, as just defined. The term “lateral” refers to a direction in the frame of reference within the horizontal plane.

A feature “connected” or “coupled” to or with another feature may be directly connected or coupled to or with the other feature or, instead, one or more intervening features may be present. A feature may be “directly connected” or “directly coupled” to or with another feature if intervening features are absent. A feature may be “indirectly connected” or “indirectly coupled” to or with another feature if at least one intervening feature is present. A feature “on” or “contacting” another feature may be directly on or in direct contact with the other feature or, instead, one or more intervening features may be present. A feature may be “directly on” or “directly contacting” another feature if intervening features are absent. A feature may be “indirectly on” or in “indirect contact” with another feature if at least one intervening feature is present. Different features may “overlap” if a feature extends over, and covers a part of, another feature. A feature may “overlie” another feature if a feature is positioned “over” another feature in a vertical direction.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A photonic structure comprising:
a first waveguide core;
a second waveguide core;
a third waveguide core;
a first ring resonator arranged between a first portion of the first waveguide core and a portion of the second waveguide core; and
a second ring resonator arranged between a second portion of the first waveguide core and a portion of the third waveguide core.

2. The photonic structure of claim 1 wherein the first waveguide core has a closed shape.

3. The photonic structure of claim 1 wherein the first waveguide core includes a third portion between the first portion and the second portion, and further comprising:
a phase shifter coupled to the third portion of the first waveguide core.

4. The photonic structure of claim 3 further comprising:
a variable optical attenuator coupled to the third portion of the first waveguide core.

5. The photonic structure of claim 1 wherein the first waveguide core includes a third portion between the first portion and the second portion, and further comprising:
a variable optical attenuator coupled to the third portion of the first waveguide core.

6. The photonic structure of claim 1 further comprising:
a third ring resonator arranged between the first ring resonator and the portion of the second waveguide core.

7. The photonic structure of claim 1 further comprising:
a first photonic integrated circuit coupled by the second waveguide core to the first ring resonator.

8. The photonic structure of claim 7 further comprising:
a second photonic integrated circuit coupled by the third waveguide core to the second ring resonator.

9. The photonic structure of claim 1 wherein the first ring resonator is configured to selectively couple light from the first portion of the first waveguide core to the second waveguide core, and the second ring resonator configured to selectively couple light from the second portion of the first waveguide core to the third waveguide core.

10. The photonic structure of claim 1 further comprising:
a Mach-Zehnder interferometer between the first portion of the first waveguide core and the second portion of the first waveguide core.

11. The photonic structure of claim 10 wherein the Mach-Zehnder interferometer includes a first arm and a second arm, and further comprising:
a first phase shifter coupled to the first arm of the Mach-Zehnder interferometer; and
a second phase shifter coupled to the second arm of the Mach-Zehnder interferometer.

12. The photonic structure of claim 1 further comprising:
a first optical coupler; and
a second optical coupler,
wherein the first ring resonator includes a fourth waveguide core having a portion that extends as a first arm from the first optical coupler to the second optical coupler.

13. The photonic structure of claim 12 further comprising:
a second arm that extends from the first optical coupler to the second optical coupler.

14. The photonic structure of claim 13 further comprising:
a first phase shifter coupled to the first arm; and
a second phase shifter coupled to the second arm.

15. The photonic structure of claim 1 wherein the first ring resonator includes a first portion adjacent to the first portion of the first waveguide core and a second portion adjacent to the portion of the second waveguide core.

16. The photonic structure of claim 15 wherein the first portion is a first side section, the second portion is a second side section, and the first ring resonator has a closed oblong shape.

17. The photonic structure of claim 1 wherein the first ring resonator includes a waveguide core, and further comprising:
a first phase shifter coupled to the waveguide core of the first ring resonator.

18. The photonic structure of claim 17 wherein the second ring resonator includes a waveguide core, and further comprising:
a second phase shifter coupled to the waveguide core of the second ring resonator.

19. The photonic structure of claim 1 wherein the first ring resonator includes a waveguide core, the second ring resonator includes a waveguide core, and the first waveguide core, the second waveguide core, the third waveguide core, the waveguide core of the first ring resonator, and the waveguide core of the second ring resonator comprise a semiconductor material.

20. A method of forming a photonic structure, the method comprising:
forming a first waveguide core, a second waveguide core, and a third waveguide core;
forming a first ring resonator arranged between a first portion of the first waveguide core and a portion of the second waveguide core; and
forming a second ring resonator arranged between a second portion of the first waveguide core and a portion of the third waveguide core.
